(19) United States
(12) Patent Application Publication
(10) Pub. No.: US 2008/0005190 A1
(43) Pub. Date: Jan. 3, 2008

(54) System, Method, Apparatus and Computer Program Product for Providing Resource Reclamation in a Virtual Machine

(75) Inventors: Daniel Fey, Budapest (HU); Gergely Herenyi, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/427,190

(22) Filed: Jun. 28, 2006

(51) Int. Cl. G06F 17/30

(52) U.S. Cl. 707/202

(57) ABSTRACT

An apparatus for providing resource reclamation in a virtual machine includes a transition detection element and an unloader element. The transition detection element is configured to detect a transition of an application in the virtual machine from foreground operation to background operation. The unloader element is configured to determine, for a class, whether criteria for unloading are met in response to detection of the transition and to unload the class in response to the criteria for unloading being met.

### TECHNOLOGICAL FIELD

Embodiments of the present invention relate generally to virtual machines, and, more particularly, relate to a system, method, apparatus, and computer program product for providing resource reclamation of applications moving to background operation in a virtual machine.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, entertain themselves, etc. in either fixed or mobile environments. However, many electronic devices which have different operating systems may require different versions of a particular application to be developed in order to permit operation of the particular application at each different type of electronic device. If such different versions were developed to correspond to each different operating system, the cost of developing software and applications would be increased.

Accordingly, virtual machines (VMs) have been developed. A VM is a self-contained operating environment that behaves as if it is a separate computer. The VM may itself be a piece of computer software that isolates the application being used by the user from the host computer or operating system. For example, Java applets run in a Java VM that has no access to the host operating system. Because versions of the VM are written for various computer platforms, any application written for the VM can be operated on any of the platforms, instead of having to produce separate versions of the application for each computer and operating system. The application may then be run on a computer using, for example, an interpreter such as Java. Java, which is well known in the industry, is extremely portable, flexible and powerful with respect to allowing applications to, for example, access mobile phone features. Thus, Java has been widely used by developers to develop portable applications that can be run on a wide variety of electronic devices or computers without modification.

Particularly in mobile environments where resources are scarce due to consumer demand to reduce the cost and size of mobile terminals, it is important to conserve or reuse resources whenever possible. In this regard, efforts have been exerted to try to conserve or reclaim resources of mobile terminals when the resources are no longer needed by a particular application. An application consumes resources during operation. When the application is no longer in use, some of the resources are reclaimable (e.g. memory) while other resources are not reclaimable (e.g. used processing time). In the case of Java applications, reclaimable resources may be divided, for example, into a first and a second group. The first group includes resources that are explicitly allocated by an application code and application programming interface (API) methods called by the application code such as, for example, plain Java objects. The second group includes resources that are implicitly allocated by the VM for the purpose of the application such as, for example, resources (mainly native structures) that are allocated by the VM during loading of the application's classes and the classes of the API implementations used by the application's classes.

With regard to the first group of reclaimable resources, garbage collection techniques have been developed to enhance reclamation of these resources. For example, once an object such as a Java object is no longer referenced it may be reclaimed by a garbage collector of the VM. However, reclamation of the second group of reclaimable resources has not been as easily done. Although certain efforts at reclamation of resources from the second group have been undertaken, such efforts are often complex and do not lend themselves to operation in certain environments or configurations such as, for example, the Java Micro Edition Connected Limited Device Configuration (CLDC), which defines the base set of application programming interfaces and a VM for resource-constrained devices like mobile phones, pagers, and mainstream personal digital assistants. Accordingly, there is a need to develop a mechanism for unloading or reclaiming resources created by the class loading process during an application's lifetime.

Given the above described problems, it may be advantageous to provide an improved mechanism for providing resource reclamation in a virtual machine.

### BRIEF SUMMARY

A system, method, apparatus and computer program product are therefore provided for providing resource reclamation in a virtual machine. In particular, a method, apparatus and computer program product are provided that perform unloading of resources that have been pre-defined as reloadable resources in response to detection of a transition of an application from foreground to background operation.

In one exemplary embodiment, a method of providing resource reclamation in a virtual machine is provided. The method includes detecting a transition of an application in a virtual machine from foreground operation to background operation, determining, for a class, whether criteria for unloading are met in response to detection of the transition and unloading the class in response to the criteria for unloading being met.

In another exemplary embodiment, a computer program product for providing resource reclamation in a virtual machine is provided. The computer program product includes at least one computer-readable storage medium having computer-readable program code portions stored therein. The computer-readable program code portions include first, second and third executable portions. The first executable portion is for detecting a transition of an application in a virtual machine from foreground operation to background operation. The second executable portion is for determining, for a class, whether criteria for unloading are met in response to detection of the transition. The third executable portion is for unloading the class in response to the criteria for unloading being met.

In another exemplary embodiment, an apparatus for providing resource reclamation in a virtual machine is provided. The apparatus includes a transition detection element and an unloader element. The transition detection element is configured to detect a transition of an application in the virtual machine from foreground operation to background operation. The unloader element is configured to determine, for a class, whether criteria for unloading are met in response to detection of the transition and to unload the class in response to the criteria for unloading being met.

In another exemplary embodiment, an apparatus for providing resource reclamation in a virtual machine is provided. The apparatus includes means for detecting a transition of an application in a virtual machine from foreground operation to background operation, means for determining, for a class, whether criteria for unloading are met in response to detection of the transition, and means for unloading the class in response to the criteria for unloading being met.

Embodiments of the invention may provide a system, method, apparatus and computer program product for providing resource reclamation in a virtual machine, which may be advantageously employed in mobile environments such as CLDC devices. However, embodiments of the invention may also be employed in other limited resource devices or even in devices having virtually unlimited resources.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a virtual machine according to an exemplary embodiment of the present invention; and

FIG. 4 is a flowchart according to an exemplary method of providing resource reclamation in a virtual machine according to one embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

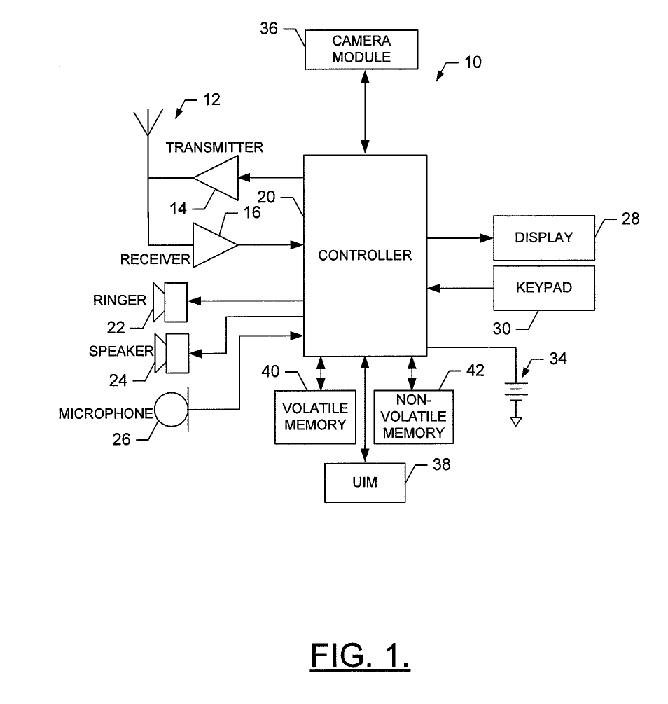

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing module 36, such as a camera, video and/or audio module, in communication with the controller 20. The media capturing module 36 may be any means for capturing an image, video and/or audio for storage, display or transmission. For example, in an exemplary embodiment in which the media capturing module 36 is a camera module, the camera module 36 may include a digital camera capable of forming a digital image file from a captured image. As such, the camera module 36 includes all hardware, such as a lens or other optical device, and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a universal identity element (UIM) 38. The UIM 38 is typically a memory device having a processor built in. The UIM 38 may include, for example, a subscriber identity element (SIM), a universal integrated circuit card (UICC), a universal subscriber identity element (USIM), a removable user identity element (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

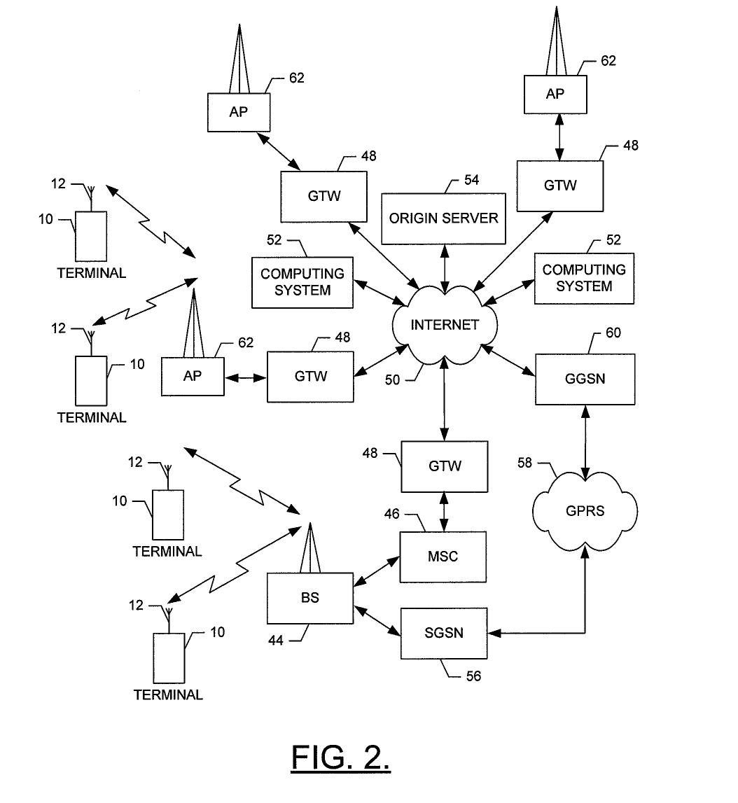

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11 g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

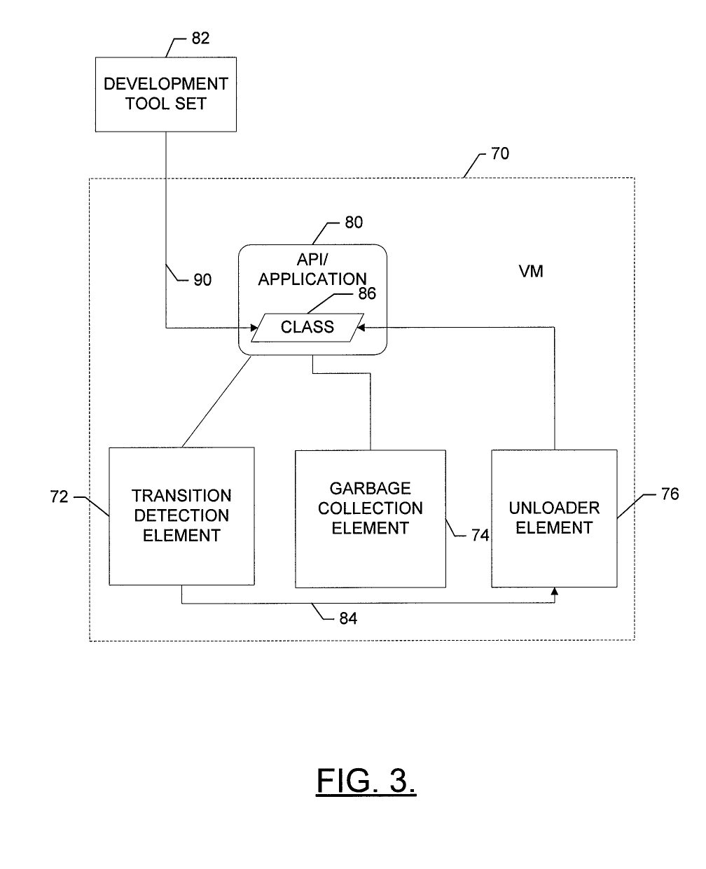

An exemplary embodiment of the invention will now be described with reference to FIG. 3, in which certain elements of a system for providing resource reclamation in a virtual machine (VM) are displayed. The VM may run, for example, on a framework of the mobile terminal 10 of FIG. 1. The framework of the mobile terminal may include the operating system of the mobile terminal 10. It should be noted, however, that while FIG. 3 illustrates merely one example of a configuration of a VM, numerous other configurations may also be used to implement embodiments of the present invention. It should also be noted that while the VM of FIG. 3 is a Java VM, any other operating system or VM may also be used. Furthermore, the VM of FIG. 3 may alternatively be embodied as any device or means embodied in either hardware, software, or a combination of hardware and software that is capable of managing code segments or classes as described below. In an exemplary embodiment, however, the VM is embodied in software as instructions that are stored on a memory of the mobile terminal 10. However, embodiments of the present invention are not to be limited merely to application in mobile terminals. As stated above, although embodiments of the invention can be advantageously employed in limited resource environments such as in CLDC devices, embodiments may also be employed in other environments as well.

Referring now to FIG. 3, a VM 70 according to an exemplary embodiment includes a transition detection element 72, a garbage collection element 74 and an unloader element 76. The VM 70 may also include one or a plurality of applications or application programming interfaces (APIs) such as application 80. The application 80 includes code segments that at least in part define the application 80. Code segments may be classified at various levels, such as by method, class, package or combinations of the previously mentioned levels. The application 80 may be, for example, developed using a development tool set 82 which provides a developer of the application 80 with tools for defining the code segments and attributes associated with the application 80.

In an exemplary embodiment, each of the transition detection element 72, the garbage collection element 74 and the unloader element 76 may be embodied as software that is capable of performing the functions associated with each respective element as described below and which operate under the control of a processing element such as, for example, the controller 20 of the mobile terminal 10 of FIG. 1. A processing element such as those described above may be embodied in many ways. For example, the processing element may be embodied as a processor, a coprocessor, a controller or various other processing means or devices including integrated circuits such as, for example, an ASIC (application specific integrated circuit). In general terms, the transition detection element 72 detects a transition of the application 80 from foreground operation to background operation. The application 80 terminates its threads that are not used in background operation, which were in use in foreground operation and subsequently clears all references to objects not used in background operation. The garbage collection element 74 finds and frees objects that are not reachable as a result of the thread termination performed by the application 80. In other words, the garbage collection element 74 reclaims resources from the first group as described in the background section. Thus, the reclaimed resources, such as memory or other reclaimable resources may be available to other applications. The unloader element 76 operates to unload certain objects from the second group of reclaimable resources as described in greater detail below.

The transition detection element 72 may be embodied as any device or means embodied in either hardware, software, or a combination of hardware and software that is capable of detecting a transition of the application 80 from foreground operation to background operation. Many applications perform background operations in, for example, a computer or an embedded electronic device having a processor and memory. While performing background operations, such applications typically do not have a user interface. However, while such applications operate in foreground operation, a user interface may be presented. In the context of embodiments of the present invention, foreground operation should be understood as operation in which the application is currently actively running and capable of receiving user input such as via a mouse, keyboard or other user input. For example, an application may function to continuously monitor a mail box for incoming mail. As such, while performing the monitoring function, the application may simply operate in the background without any user interface. However, when new mail arrives, the application may shift to foreground operation and function to inform the user that the new mail has arrived and provide a user interface to allow the user to select the new mail for download, deletion, forwarding, etc. For the duration of foreground operation, the user interface may be functional within the application. When the application transitions to return to background operation, the user interface may be lost. Accordingly, some resources associated with the user interface may no longer be in use and could be reclaimed. While the scenario above regarding the user interface presents one example of an instance in which it may be desirable to reclaim resources that are rendered unused by a transition from foreground operation to background operation, other instances exist as well. Thus, the transition detection element 72 is configured to monitor the application 80 for a transition from foreground operation to background operation and determine when such transition has occurred. The transition detection element 72 may then provide an indication 84 of the transition to the unloader element 76.

The application 80 may perform the transition from foreground operation to background operation in response to a decision made either within the application 80 or within an application management framework of the VM 70. If the application management framework of the VM 70 makes the decision to send the application 80 to background operation, a special API method may be employed to direct the application 80 to enter the background operation mode. It should also be noted that although the example described above refers to an initial transition from background to foreground operation, no such transition is required. In other words, the transition detection element 72 may detect a transition from foreground operation to background operation regardless of whether a preceding transition occurred from background operation to foreground operation.

As stated above, after transitioning from foreground operation to background operation, the application 80 may stop all of the threads of the application 80 (in a cooperative manner) which will not be used in background operation and clear all references to objects that will not be used in background operation. For example, if the application 80 registered listener objects, and in background operation there is no need to use previously registered listeners, the application 80 may deregister the listener objects in order to remove all references to the listener objects to enable removal of the objects by the garbage collection element 74.

The garbage collection element 74 may be embodied as any device or means embodied in either hardware, software, or a combination of hardware and software that is capable of identifying and freeing all objects that are no longer referenced and therefore are not reachable. In an exemplary embodiment, the garbage collection element may operate to free the objects which had all references cleared by operation of the application to clear all references to objects that will not be used in background operation as described above. In this regard, objects from the first group of reclaimable resources (i.e., resources that are explicitly allocated by an application code and API methods called by the application code) are reclaimed using the garbage collection element 74 following the transition from foreground operation to background operation.

The unloader element 76 may be embodied as any device or means embodied in either hardware, software, or a combination of hardware and software that is capable of unloading (or reclaiming) resources which were initially consumed during a class loading process which occurs during a lifetime of the application. In an exemplary embodiment, the unloader element 76 may operate in response to receipt of the indication 84 of the transition from the transition detection element 72 in order to reclaim selected second group resources, which are reclaimable resources that are allocated implicitly by the VM 70 for the purpose of the application 80. For example, in response to receipt of the indication 84, the unloader element 76 may examine a class 86 (or a plurality of classes) of the application 80 (or of APIs used by the application 80) to determine if the class 86 meets criteria for unloading. In an exemplary embodiment, the criteria for unloading may include that the class 86 has no instantiated objects and is marked as being re-loadable. If the class 86 meets the criteria for unloading, the class 86 may be unloaded regardless of whether the class 86 is defined by the application's code or by APIs used by the application 80. It should be noted that an instantiated object is defined as an instantiated object from either a class or the subclasses of the class. As such, a class will not be unloaded if an object is instantiated from the class or subclasses of the class.

As stated above, the criteria for unloading may include that the class 86 has no instantiated objects and is marked as being re-loadable. In this regard, the unloader element 76 may be capable of determining whether the class 86 has any instantiated objects and whether the class 86 is marked as being re-loadable. When a class is unloaded, an accumulated state of the class will be lost. The internal state of a class is represented by static fields of the class which are sometimes called class variables. If a field of, for example, a Java class is declared static, there exists exactly one incarnation of the field, no matter how many instances (possibly zero) of the class may eventually be created. A static field is incarnated when the class is initialized. In some cases, re-initializing of a class (which may occur if re-loading the class) is acceptable. However, some classes may not support such a procedure depending on the nature of their accumulated state.

Accordingly, during development of the application 80, the developer of the application 80 may employ the development tool set 82 to provide an annotation 90 to each class 86 of the application 80 that is re-loadable. It should be understood that the annotation 90 could be a flag, marker, etc. or even absence of a flag, marker, etc. In fact, the annotation 90 could be any mechanism by which re-loadable and not re-loadable classes may be differentiated. For example, a re-loadable class may have a marker comprising data indicative of re-loadability while a not re-loadable class has no marker. Alternatively, the re-loadable class may have a marker comprising data indicative of re-loadability while the not re-loadable class has a marker comprising data indicative of non re-loadability. As yet another alternative, the re-loadable class may have no marker while the not re-loadable class has marker comprising data indicative of non re-loadability.

As such, the development tool set 82 may be any tool set known in the art which is capable of enabling a developer to develop the application 80, except that the development tool set 82 also includes the ability to provide the annotation 90 to each class 86 of the application 80. When the developer is developing the application 80, consideration of the attributes of each class may be given in deciding whether the class 86 should be designated as being re-loadable or not re-loadable. In general, a class may be considered re-loadable for any reason selected by the developer. However, a re-loadable class may be designated as such based on the presence of internal state data, or the acceptability of erasing accumulated state data for the class. In other words, if a particular class has no internal state or if the particular class can be successfully re-loaded after having its accumulated state erased, the particular class may be designated as re-loadable. Other factors may also influence the developer in making the designation such as, for example, the time it might take to mark a class as re-loadable. For example, the time to reload the class may be compared to a threshold and if the time to reload is above the threshold, the class may be considered not re-loadable. In other words, if it would be very time consuming to re-load a class, the class may be marked as not re-loadable even, for example, in the absence of an internal state for the class. Still other factors such as the impact of re-loading the class on performance may also be considered. In this regard, the developer may make a decision as to whether the class is to be predefined as being re-loadable in response to a determination that the performance of the class will be sufficient upon reloading of the class.

Accordingly, as stated above, when loading a class for foreground operation, certain resources are consumed. When the application 80 goes to background operation reclaimable portions of the resources may be sought out for reclamation. In this regard, the application 80 itself will stop threads that are not used in background operation and the garbage collection element 74 may free objects that are not reachable when references to the objects are removed by the application 80 following thread stoppage. Thus, reclaimable resources of the first group are reclaimed. Reclaimable resources of the second group are then selectively reclaimed by the unloader element 76 in response to receipt of the indication 84 of the transition from foreground to background operation. The selective reclamation is performed based on examination of each class 86 associated with the application 80 with respect to criteria for unloading. In this regard, in an exemplary embodiment, resources are reclaimed or unloaded in response to a determination that there are no instantiated objects associated with the class 86 and that the class has been previously marked or predefined as being re-loadable. Such resource reclamation via unloading is performed on the class regardless of whether the class is defined by the application's code or by the APIs used by the application.

If the VM 70 is capable of running multiple applications at the same time, such as multiple Java applications, consideration may be given to shared resources between the applications. For example, if resources are consumed as a result of loading a particular class that is shared between different isolated applications, it may be undesirable to un-load the shared class if the shared resources are needed by the other application. Accordingly, the unloader element 76 may include additional functionality for determining whether the class is shared with other applications as a prerequisite to unloading. In this regard, if the class is shared and the resources shared with another class are needed by the other class, then the class may not be unloaded regardless of the fact that the class is marked as re-loadable and a determination has been made that there are no instantiated objects associated with the class.

As stated above, embodiments of the present invention may be employed in numerous fixed and mobile devices. In this regard, embodiments of the present invention may be useful in maximizing resource reclamation efforts, which is particularly important in mobile environments. As such, embodiments of the present invention provide a mechanism by which to reclaim additional resources, such as reclaimable resources of the second group, which otherwise may not be reclaimed. Additionally, embodiments of the present invention provide a simpler mechanism for unloading objects than conventional methods, thereby reducing resource consumption, which is also advantageous in mobile environments. Furthermore, even in environments that are not resource constrained, simplifying a process for reclaiming resources may allow expanded capacity for handling high volumes of different applications with a lower cost.

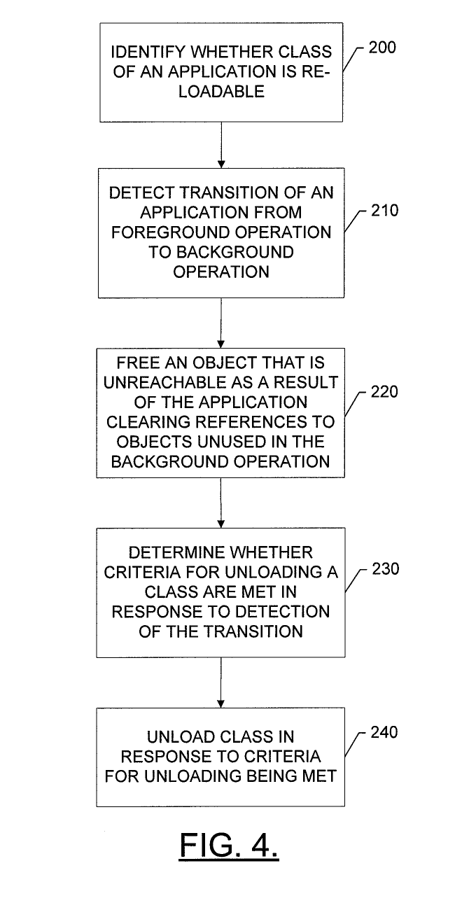

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing resource reclamation in a virtual machine, as shown in FIG. 4, may include an optional initial operation of identifying whether the class associated with the application is re-loadable at operation 200. A class may be identified as being re-loadable in response to, for example, either a determination that the class has no state information, or a determination that the class is loadable without accumulated state information. A class that has been identified as being re-loadable may then be predefined as being re-loadable in response to either a determination that reload time for the class is below a threshold, or that a performance of the class is expected to be sufficient in response to reloading the class. A transition of an application in a virtual machine from foreground operation to background operation is detected at operation 210. At operation 220, an optional operation of freeing an object that is unreachable as a result of the application clearing references to objects that will be unused in the background operation is performed. At operation 230, a determination is made as to whether criteria for unloading are met for a class in response to detection of the transition. The criteria for unloading may include a determination that the class has no instantiated objects, and a determination that the class has been predefined to be re-loadable. The class is unloaded at operation 240 in response to the criteria for unloading being met. However, if more than one application may be run at one time, then unloading of the class may further depend on a determination that the class is not shared with another application, or a determination that the class is shared with another application and that the shared class is not needed by the other application.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
detecting a transition of an application in a virtual machine from foreground operation to background operation;
determining, for a class, whether criteria for unloading are met in response to detection of the transition; and
unloading the class in response to the criteria for unloading being met.

2. A method according to claim 1, wherein determining whether the criteria for unloading are met comprises:
determining that the class has no instantiated objects; and
determining that the class has been predefined to be re-loadable.

3. A method according to claim 2, further comprising an initial operation of identifying whether the class of the application is re-loadable.

4. A method according to claim 3, wherein identifying whether the class is re-loadable comprises one of:
determining that the class is re-loadable if the class has no state information; or
determining that the class is re-loadable if the class is loadable without accumulated state information.

5. A method according to claim 4, further comprising predefining the class as re-loadable if the class is identified to be re-loadable and a reload time for the class is below a threshold.

6. A method according to claim 4, further comprising predefining the class as re-loadable if the class is identified to be re-loadable and an anticipated performance of the class is sufficient in response to reloading the class.

7. A method according to claim 1, wherein unloading the class that meets the criteria for unloading is performed in response to one of:
determining that the class is not shared with another application; or
determining that the class is shared with another application and that the shared class is not needed by the other application.

8. A method according to claim 1, further comprising freeing an object that is unreachable as a result of the application clearing references to objects unused in the background operation prior to determining whether the criteria for unloading are met.

9. A computer program product comprising at least one computer-readable storage medium having computer-readable program code portions stored therein, the computer-readable program code portions comprising:
a first executable portion for detecting a transition of an application in a virtual machine from foreground operation to background operation;
a second executable portion for determining whether criteria for unloading are met in response to detection of the transition; and
a third executable portion for unloading a class that meets the criteria for unloading.

10. A computer program product according to claim 9, wherein the second executable portion includes instructions for:
determining that the class has no instantiated objects; and
determining that the class has been predefined to be re-loadable.

11. A computer program product according to claim 10, further comprising a fourth executable portion for an initial operation of identifying whether the class of the application is re-loadable.

12. A computer program product according to claim 11, wherein the fourth executable portion includes instructions for identifying whether the class is re-loadable via one of:
determining that the class has no state information; or
determining that the class is loadable without accumulated state information.

13. A computer program product according to claim 12, wherein the fourth executable portion includes instructions for predefining the class as re-loadable if the class is identified to be re-loadable and a reload time for the class is below a threshold.

14. A computer program product according to claim 12, further comprising a fifth executable portion for predefining the class as re-loadable if the class is identified to be re-loadable and an anticipated performance of the class is sufficient in response to reloading the class.

15. A computer program product according to claim 9, wherein the third executable portion is executed in response to one of:
determining that the class is not shared with another application; or
determining that the class is shared with another application and that the shared class is not needed by the other application.

16. A computer program product according to claim 9, further comprising a fourth executable portion for freeing an object that is unreachable as a result of the application clearing references to objects unused in the background operation prior to execution of the second executable portion.

17. An apparatus comprising:
a transition detection element configured to detect a transition of an application in a virtual machine from foreground operation to background operation; and
an unloader element configured to determine, for a class, whether criteria for unloading are met in response to detection of the transition and to unload the class in response to the criteria for unloading being met.

18. An apparatus according to claim 17, further comprising a garbage collection element configured to free an object that is unreachable as a result of the application clearing references to objects unused in the background operation.

19. An apparatus according to claim 17, wherein the criteria for unloading comprise:
a determination that the class has no instantiated objects; and
a determination that the class has been predefined to be re-loadable.

20. An apparatus according to claim 17, wherein the unloader element is configured to unload the class that meets the criteria for unloading in response to one of:
a determination that the class is not shared with another application; or
a determination that the class is shared with another application and that the shared class is not needed by the other application.

21. An apparatus according to claim 17, wherein the apparatus is embodied as a mobile communication device.

22. A system comprising:
a development tool set configured to develop an application; and
a virtual machine in communication with the development tool set, the virtual machine including:
a transition detection element configured to detect a transition of the application from foreground operation to background operation; and
an unloader element configured to determine, for a class, whether criteria for unloading are met in response to detection of the transition and to unload the class in response to the criteria for unloading being met.

23. A system according to claim 22, wherein the virtual machine further comprises a garbage collection element configured to free an object that is unreachable as a result of the application clearing references to objects unused in the background operation.

24. A system according to claim 22, wherein the criteria for unloading comprise:
a determination that the class has no instantiated objects; and
a determination that the class has been predefined to be re-loadable.

25. A system according to claim 22, wherein the unloader element is configured to unload the class that meets the criteria for unloading in response to one of:
a determination that the class is not shared with another application; or
a determination that the class is shared with another application and that the shared class is not needed by the other application.

26. A system according to claim 22, wherein the development tool set is in communication with the application during development of the application and is configured to enable identifying whether the class of the application is re-loadable.

27. A system according to claim 26, wherein the development tool set is employed to identify that the class is re-loadable in response to one of:
a determination that the class has no state information; or
a determination that the class is loadable without accumulated state information.

28. A system according to claim 27, wherein the development tool set is configured to predefine the class as re-loadable if the class is identified to be re-loadable and a reload time for the class is below a threshold.

29. A system according to claim 27, wherein the development tool set is configured to predefine the class as re-loadable if the class is identified to be re-loadable and an anticipated performance of the class is sufficient in response to reloading the class.

30. An apparatus comprising:
means for detecting a transition of an application in a virtual machine from foreground operation to background operation;
means for determining, for a class, whether criteria for unloading are met in response to detection of the transition; and
means for unloading the class in response to the criteria for unloading being met.

31. An apparatus according to claim 30, wherein the means for determining whether the criteria for unloading are met comprises:
means for determining that the class has no instantiated objects; and
means for determining that the class has been predefined to be re-loadable.
